(19) United States
(12) Patent Application Publication
(10) Pub. No.: US 2022/0065409 A1
(43) Pub. Date: Mar. 3, 2022

(54) ADAPTABLE LED LIGHT STRING

(71) Applicant: Ledup Manufacturing Group Limited, Irwindale, CA (US)

(72) Inventor: Jing Jing Yu, Irwindale, CA (US)

(73) Assignee: Ledup Manufacturing Group Limited, Irwindale, CA (US)

(21) Appl. No.: 17/451,449

(22) Filed: Oct. 19, 2021

Related U.S. Application Data
(62) Division of application No. 17/011,144, filed on Sep. 3, 2020.

(51) Int. Cl. F21S 4/10; H05B 45/37; F21V 23/06; F21V 23/02; F21V 23/00; H05B 47/155; H05B 45/10; H05B 47/175; H05B 45/40

(52) U.S. Cl. CPC F21S 4/10; H05B 45/37; F21V 23/06; F21V 23/023; F21W 2121/04; H05B 47/155; H05B 45/10; H05B 47/175; H05B 45/40; F21V 23/005

(57) ABSTRACT

Disclosed are embodiments of adaptable LED light strings that can be configured by a user to decorate Christmas trees, outdoor features such as houses and patios, outdoor trees, windows and architecture of houses. A plurality of light string channels are used, which are connected to individual light strings which can be shorter strings that are easy to install and remove. In some embodiments, light strings may be configured to connect to additional light strings to provide longer light strings. Each of the light string channels can be individually controlled to produce different effects on each of the light strings.

### CROSS-REFERENCE TO RELATED APPLICATION

This Non-Provisional patent application is a divisional of U.S. patent application Ser. No. 17/011,144, which was filed with the United States Patent and Trademark Office on Sep. 3, 2020, which is specifically incorporated herein by reference for all that it discloses and teaches.

### BACKGROUND

LEDs have been widely used for decorative lighting purposes because of their low cost, low electrical power consumption and long lifetime. For example, LED light strings have taken the place of many conventional incandescent light strings.

### SUMMARY

An embodiment of the present invention may therefore comprise a method of making an adaptable light emitting diode (LED) direct current light string system comprising: converting an alternating current signal into a direct current signal using a converter that is disposed in a wall plug; applying the direct current signal to a controller that produces a plurality of separate light string channels; connecting separate LED light strings to each of the plurality of separate light string channels; separately controlling the plurality of separate light string channels and LED light strings connected to the plurality of separate light string channels using the controller.

An embodiment of the present invention may further comprise an adaptable light emitting diode (LED) direct current light string system comprising: a wall plug; an AC to DC converter circuit disposed in the wall plug that produces a DC signal; a controller that receives the DC signal from the wall plug and generates a plurality of separate light string channels of direct current leads that are separately controlled by the controller; a plurality of light strings having a same number of LEDs, the plurality of light strings connected to the plurality of separate light string channels so that the plurality of light strings are separately controlled by the controller.

An embodiment of the present invention may further comprise a method of making an adaptable light emitting diode (LED) alternating current light string system comprising: applying an AC signal to a controller; generating a plurality of light string channels from the controller: applying the plurality of light string channels to a plurality of front adapters; connecting the plurality of front adapters to a plurality of light strings; connecting the plurality of light strings to a plurality of back adapters; connecting the plurality of front adapters and the plurality of back adapters in the plurality of light strings to produce a full wave rectified DC signal that is connected to a plurality of LEDs in the plurality of light strings; controlling the plurality of light strings using the controller.

An embodiment of the present invention may further comprise an adaptable light emitting diode (LED) alternating current light string system comprising: a wall plug connected to an alternating current source; a controller connected to the wall plug that generates a plurality of light string channels that are separately controlled by the controller; front adapter circuits connected to the plurality of light string channels; a plurality of LED light strings connected on a first end to the front adapter; back adapter circuits connected to a second end of the plurality of LED light strings so that the front adapter and the back adapter are connected to function together to generate a full wave rectified DC signal; a plurality of LEDs disposed in the plurality of LED lights strings that are connected to the full wave rectified DC signal that are illuminated in response to the controller.

### BRIEF DESCRIPTION OF THE DRAWINGS

FIG. 1 is a schematic circuit diagram illustrating an embodiment of the invention.

FIG. 2 is a schematic diagram illustrating an AC to DC converter plug.

FIG. 3 is a schematic block diagram of an AC to DC converter circuit for use in a plug.

FIG. 4 is a schematic circuit diagram of an AC to DC converter for use in a plug.

FIG. 5 is another embodiment of an adaptable LED light string.

FIG. 6 is another embodiment of an adaptable LED light string.

FIG. 7 is another embodiment of an adaptable LED light string.

FIG. 8 is another embodiment of an adaptable LED light string.

FIG. 9 is a schematic illustration of the manner in which the above disclosed embodiments can be used with respect to a Christmas tree.

FIG. 10 is a schematic illustration of another manner in which the various embodiments disclosed above can be used on a Christmas tree.

### DETAILED DESCRIPTION OF THE EMBODIMENTS

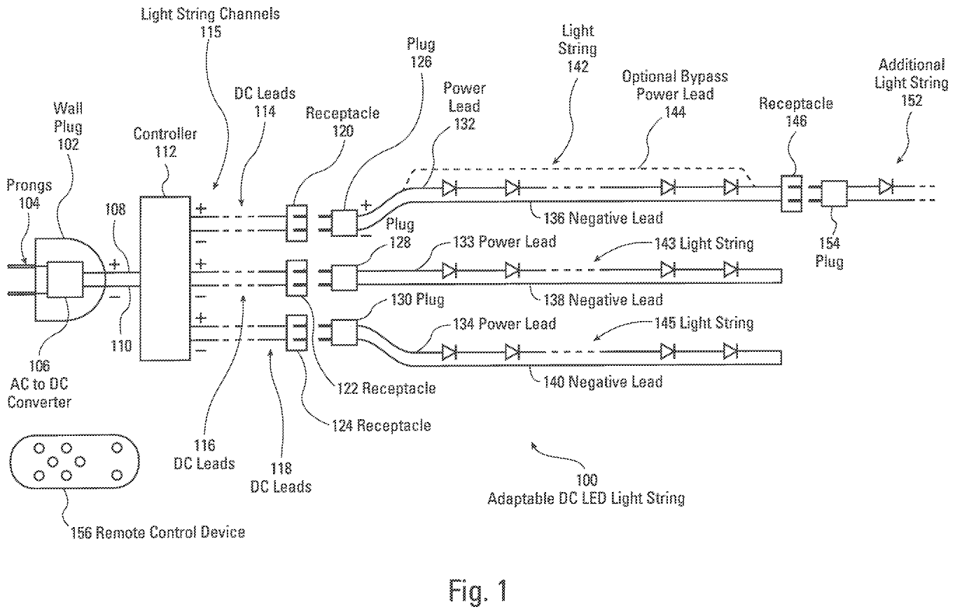

FIG. 1 is a schematic diagram of an embodiment of an adaptable DC LED light string. As illustrated in FIG. 1, a wall plug 102 has prongs 104 that are suitable for plugging into a standard AC outlet. In the U.S., these outlets provide approximately 60 Hertz and 117 volt RMS AC current. The prongs are connected to an AC to DC converter 106 that converts the AC signal into a DC signal. The DC signal ranges from about 5 volts to about 45 volts. The positive output DC voltage signal 108 and the negative output signal 110, which may be 0 volts, is applied to a controller 112. Controller 112 can be operated using a remote control device 156 to control the operation of the light string 142, light string 143, and light string 145. For example, controller 112 is able to control intensity, colors, blinking, fading and other functions of the light string 142, light string 143, and light string 145. This is disclosed in more detail in U.S. Pat. No. 10,452,602 issued Jan. 21, 2020 to Jing Jing Yu, entitled “Individually Accessible LED Light System,” which is specifically incorporated herein for all that it discloses and teaches. Controller 112 generates a series of light string channels 115 that are embodied in the DC leads 114, 116, 118. Each of these light string channels 115 is a separate light string channel for controlling the operation of the light strings 142, 143, 145. Each of the light string channels 115 is capable of being controlled by the controller 112, which controls intensity, colors, blinking, fading and other functions desired to be controlled by a user. Since the light string channels 115 are separate light string channels, each of the channels can be controlled individually to produce different effects on each of the light strings 142, 143 and 145. The controller 112 has a series of DC output leads such as DC leads 114, DC leads 116, and DC leads 118. Each pair of leads comprises a positive and negative voltage output. The DC leads may be modulated with control signals for controlling operation of the LEDs or the DC voltage level may simply be varied by controller 112. The DC leads, 114, 116, 118 are connected to receptacles 120, 122, 124, respectively. The DC leads 114, 116, 118 may have any desired length so that the receptacle 120 can be adjacent to the area to be lighted by the light string 142, light string 143, and light string 145.

As also shown in FIG. 1, plug 126 is connected to light string 142. A positive power lead 132 is connected to a series of light-emitting diodes to illuminate the light-emitting diodes. Negative lead 136 is connected from plug 126 to receptacle 146. An optional bypass power lead 144 can be utilized which connects the plug 126 to the receptacle 146 so that full power can be supplied to the receptacle 146 regardless of the number of LEDs that are used in the power lead 132. Each of the lights strings 143 and 145 can also include an optional bypass power lead, such as optional bypass power lead 144, if it is desired to have additional light strings, such as additional light string 152, connected to light strings 143, 145. By providing full power at receptacle 146, additional light strings 152 can be supplied with full DC power.

Plug 128 of light string 143 of FIG. 1, plugs into receptacle 122. Power lead 133 supplies power to the light-emitting diodes of light string 143. Negative lead 138 runs from plug 128 to the end of light string 146. Power lead 133, after passing through the light-emitting diodes, is connected to negative lead 138. Further, plug 130 of light string 145 is inserted in receptacle 124 to supply DC power to light string 145. The power lead 134 supplies power to the LEDs of light string 145. Power lead 134 is connected to the negative lead 140 at the end of the light string 145. Negative lead 140 runs from the plug 130 to the end of the light string 145.

The innovative design of FIG. 1 allows users to use multiple different strings that are plugged into separate DC electrical supplies, such as receptacles 120, 122, 124, to ease the process of decorating a tree. It is easier to place separate shorter light strings, such as light strings 142, 143 and 145 on a tree, and to remove those strings separately, rather than stringing a very long string around a tree. Further, if longer light strings are needed, a receptacle at the end of the light string allows additional light strings to be used to increase the length of the string when a by-pass power lead is provided. In addition, any desired number of light string channels can be supplied by a controller 112 to provide more options for separately stringing light strings. In some outdoor applications, it is desirable to have separate strings to supply separate decorative lighting features and to separately control each one of those light strings to create different effects, such as different colors, flashing, fading, variations in intensity and other effects, such as disclosed in U.S. Pat. No. 10,542,602. For example, separate features may include use on different windows on a house, different portions of a house, different trees located in a yard, etc., which are all connected to a single source (controller 112) and can be separately controlled by the controller 112. Currently, separate individual light strings connected by extension cords to a house have been used and each of these strings, if it can be controlled, are controlled from a plurality of different controllers.

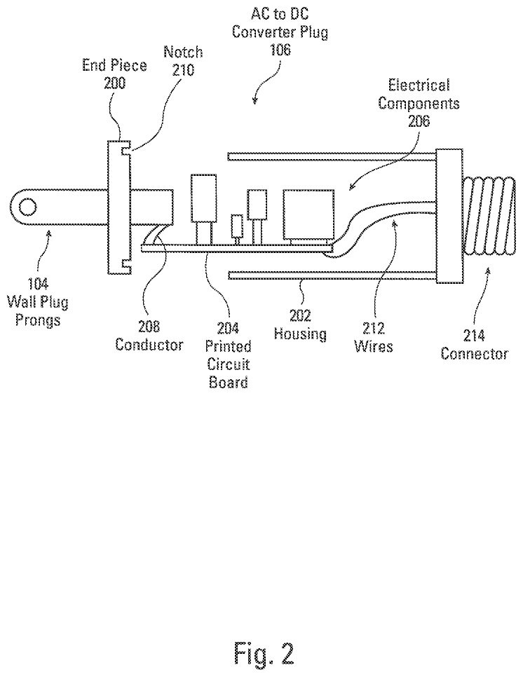

FIG. 2 is a schematic diagram of an embodiment of an AC to DC converter plug. The AC to DC converter plug 106 has been disclosed in U.S. Pat. No. 8,836,224, issued Sep. 16, 2014, entitled “Compact Converter Plug for LED Light Strings” to Chen et al. The AC to DC converter 106 is illustrated in FIG. 1, disposed in the wall plug 102, and is illustrated in detail in FIG. 2. The AC to DC converter plug 106 is constructed so that it is waterproof or watertight and can be used in exterior wall sockets. As illustrated in FIG. 2, wall plug prongs 104 are connected to end piece 200. Wall plug prongs 104 may be molded in the end piece 200 using various molding techniques so that the wall plug prongs 104 are securely mounted and sealed in the end piece 200. End piece 200 includes notch 210 which engages the housing 202 to provide a secure, watertight seal between the end piece 200 and the housing 202. A conductor 208 connects the wall plug prongs 104 to the printed circuit board 204. Wires 212 connect the printed circuit board 204 to the connector 214. The mating of the housing 202 with the end piece 200 can be by way of a friction fit, ultrasonic welding, or other standard process for creating a watertight fit. In this manner, the converter plug 102 can be used in outdoor environments while maintaining a watertight seal for electrical components 206 mounted on the printed circuit board 204 inside the housing 202.

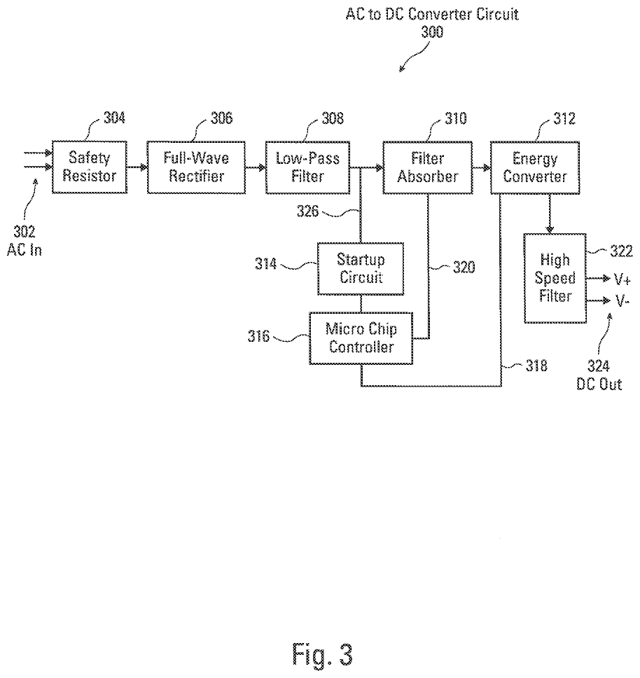

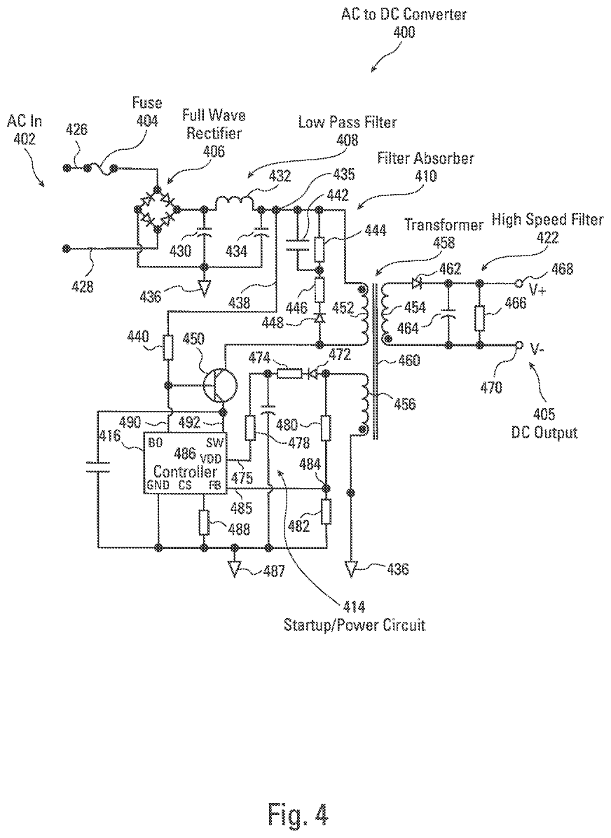

FIG. 3 is a schematic block diagram of an embodiment of a converter circuit 200 that can be used in the wall plug 102 (FIG. 1). As illustrated in FIG. 3, an alternating current input 302 is applied to the safety resistor 304. Safety resistor 304 may be a resistive fuse that blows when an excessive amount of current is applied to the converter circuit 300 or simply an in-line resistor. The alternating current signal 302 is then applied to a full-wave rectifier 306 which rectifies the alternating current input 302 into a fully rectified wave form. A low-pass filter 308 filters out higher frequencies so that a direct current signal is produced at the input of the filter absorber 310. Filter absorber 310 absorbs current spikes to protect the microchip controller 316, energy converter 312 and other components in the converter circuit 300. The direct current signal is then applied via connector 326 to startup circuit 314. Startup circuit 314 assists in starting the microchip controller 316 and providing a source of direct current power to operate the microchip controller 316. Energy converter 312 includes a high speed switching circuit and a transformer that reduces the voltage level of the direct current voltage signal. High speed filter 322 creates the direct current output 324. This circuit is shown in more detail in FIG. 4.

FIG. 4 is a circuit diagram of an embodiment of the circuit diagram of and AC to DC converter 400. As illustrated in FIG. 4, an alternating current signal 402 is applied to the leads 426, 428. Fuse or safety resistor 404 is a 10 ohm winding resistor installed in the alternating current power on lead 426. If a short circuit or other abnormal condition occurs fuse 404 produces an open circuit and prevents the application of alternating current input power to the AC to DC converter circuit 400. Fuse 404 also limits the current fluctuation during on and off transitions. Full wave rectifier 406 rectifies the alternating current input 402 to produce a pulsed direct current voltage. Low pass filter 408, which comprises capacitors 430, 434 and inductor 432, generates a direct current voltage at node 435. Lead 438 applies the direct current voltage to resistor 440 and to the base of switching transistor 450. Direct current voltage at node 435 is also applied to filter absorber 410, which comprises capacitor 442, resistor 444, resistor 446 and diode 448. Filter absorber 410 protects the switching transistor 450 from voltage spikes that may occur during operation of the transformer 458.

As also shown in FIG. 4, switching transistor 450 is controlled by controller 416. A suitable controller for use as controller 416 for low power converters comprises part #FT831B,FT881 from Fremont Microdevices Limited, #5-8,10-F, Chang-Hong Science and Technology Building, Ke-Jiman 12 Road, Nanshan District, Shenzhen, Guangdong. For higher power converters, part #ACT361,ACT355 is available from Active-Semi Inc., 2728 Orchard Parkway, San Jose Calif. 95134 or from iWatt, Inc. 101 Albright Way, Los Gatos, Calif. 95032.

Switching transistor 450 of FIG. 4 is turned on and off by pins 490, 492 of controller 486 which modulates the direct current voltage at node 435. Since the direct current voltage of node 435 is modulated, the voltage transitions are transmitted from the primary coil 452 of transformer 458 to secondary coils 454, 456 via transformer coil 460. The transitioning voltage across coil 452 induces a voltage in secondary coil 454. The voltage transition occurs in both a positive and negative direction on coil 452. This causes both positive going and negative going voltage transitions to be induced in secondary coils 454, 456. Diode 462 only allows the current to pass in the direction of the diode 462. The high speed filter 422, which comprises capacitor 464 and resistor 466, filters and stores the positive direct current voltage on node 468 and the negative output direct current voltage on node 470 of direct current output voltage 405.

As also illustrated in FIG. 4, transitioning voltages on primary coil 452 also create transitioning voltages on secondary coil 456 that are applied to the startup circuit 414 and the voltage dividing circuit comprising resistors 480, 482. With regard to the startup circuit 414, diode 472 only allows passage of current in the direction of diode 472. Resistors 474, 478 and capacitor 476 provide a voltage at pin 475 which is the VDD voltage that operates the controller 486. The voltage dividing circuit, that comprises 480, 482, provides a voltage at node 484, which is the induced voltage on secondary coil 456 divided between resistors 480, 482. The voltage on node 484 is applied to the feedback pin 485 of controller 486. The voltage at feedback pin 485 of controller 486 controls the frequency of switching on nodes 490, 492 of controller 486. When there is no load at the DC output 405, the frequency is reduced to achieve energy savings. When a load is present at DC output 405, the frequency of the switching transistor 450 is increased which delivers more energy across the transformer 458 from primary coil 452 to secondary coil 456 to support the energy requirements of the load at DC output 405. Secondary coil 456 has a proportional amount of energy transferred from the primary coil 452 as a secondary coil 454, depending upon the number of windings in secondary coil 454 and the secondary coil 456. Hence, secondary coil 456 has the same, or a proportional amount, of energy delivered to the secondary coil 456, as the secondary coil 454. In other words, the secondary coil 454 has a certain amount of energy delivered across the transformer 458 and secondary coil 456 has the same, or a proportional amount of energy, delivered to secondary coil 456. Hence the voltage at node 484 is proportional to the voltage produced at the DC output 405. In this manner, the controller 486 can monitor the voltage that is produced at the DC output 405 without any feedback from DC output 405. Optical couplers have been used to provide a feedback loop from an output voltage such as DC output voltage 405, which provides isolation between a direct current output and a controller, such as DC output 405 and controller 486. However, optical couplers are expensive and bulky. In order to maintain a small package that has a size that is consistent with a wall plug, optocouplers provide an inconvenient solution that does not meet the size requirements for the miniature AC to DC converter 400 that is employed in wall plug 102 (FIG. 1).

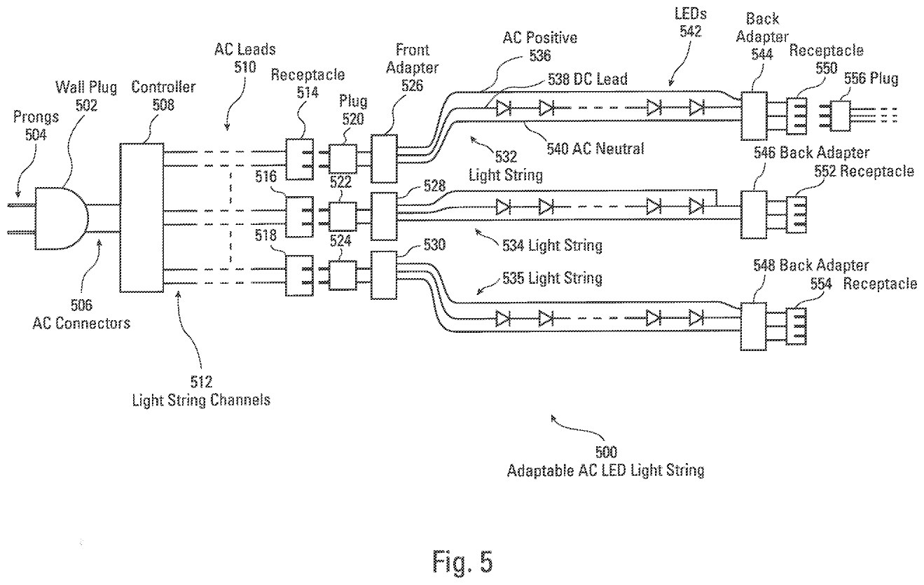

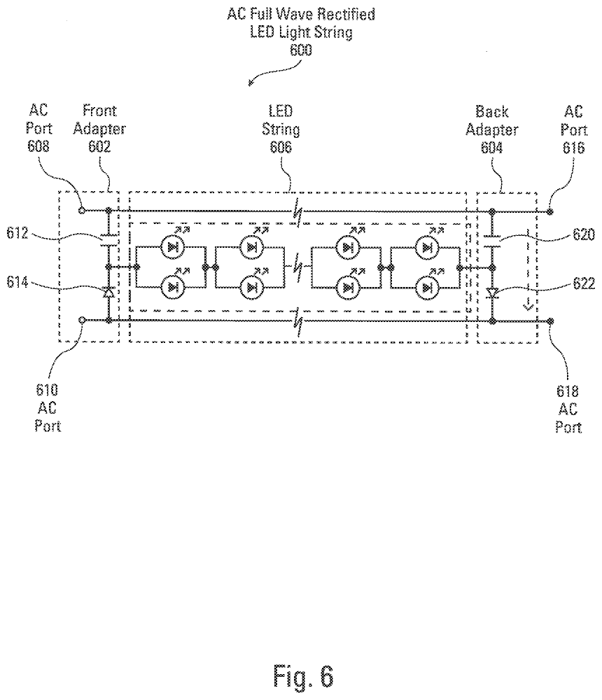

FIG. 5 is another embodiment of an adaptable LED light string 500. As illustrated in FIG. 5, wall plug 502 has prongs 504 that engage a wall socket that provides an alternating current signal, such as a 117 volt RMS, 60 cycle signal. The AC signal is transmitted to controller 508 using AC connectors 506. Controller 508, in the same manner as controller 112 (FIG. 1), allows a user to control the light strings, such as light strings 570, 572, 574. Controller 508 produces a plurality of light string channels that are separately controlled by controller 508. The light string channels are embodied in a series of AC output signals on AC leads 510. Any desired number of different light string channels can be produced depending upon the number of separate channels that are desired. The AC leads 510 provide an AC positive and AC neutral signal that are connected to receptacles 514, 516, 518. Plugs 520, 522, and 524 engage receptacles 514, 516, 518, respectively, to provide power to front adapters 526, 528, 530. The front adapters 526, 528, 530 produce an output signal that comprises an AC positive signal 536, a DC signal 538 and an AC neutral signal 540. Similar signals are created by front adapter 528, 530. A ground connection can also be provided. Light string 532 is connected to front adapter 526. Light string 572 is connected to front adapter 528, and light string 535 is connected to front adapter 535. The light string 532 comprises an AC positive lead 536, an AC neutral lead 540 and a DC lead 538 which is connected to series connected LEDs 542. Each of the LED light strings 532, 534, 535 are connected to back adapters 544, 546 and 548 respectively. Each of the back adapters are connected to receptacles 550, 552, 554. Receptacles 550, 552, 554 can be connected to plugs of additional light strings. Any number of additional light strings can be connected in series with the light string 570. The adaptive light string 500 is not sensitive to load so as many or as few LEDs can be used in a light string without adjusting components of the string, and as many additional light strings as desired can be connected in series without changing the design of the light string. FIGS. 6, 7 and 8 illustrate three different embodiments of front adapters and back adapters that can be used in the device illustrated in FIG. 5.

The advantages of the adaptable LED light string 500 is that the adaptable LED light string 500 is not sensitive to load. As few or as many LEDs as needed can be placed in the DC positive line 538 without affecting intensity of the LEDs. Further, as many additional light strings as desired can be plugged in series to any of the channels without affecting the amount of power delivered to the additional series light strings and without affecting the intensity. This is useful in large outdoor environments where a large number of light strings are required to be placed along a long perimeter or other lengthy or extensive use. In addition, the multiple channels, such as the three channels shown in FIG. 5, allows for convenient uses of other light strings in environments located closely to the controllers and adapters, or in additional long strings. Another advantage of having multiple channels is the controller 508 can very simply control each of the channels as desired by the user.

FIG. 6 is an embodiment of a full wave rectified LED light string 600 that can be used in association with the light strings 532, 534, 535, illustrated in FIG. 5. FIGS. 6, 7 and 8 illustrate three embodiments of constant current power supplies. LED lights strings are typically driven by a voltage power supply. Therefore, resistors are often used to match the LEDs' operating voltage. One common problem with such LED light strings is that one must use different resistors for strings with a different number of LEDs. The resistors often consume as much electrical power as the LEDs. Moreover, if one LED fails, it will affect the rest of the LEDs. Therefore, a constant current power supply is the best driver for an LED string. However, current power supplies are not widely used for LED light strings because of the high cost associated with these current power supplies.

Instead of using four diodes in a traditional four-way rectifying circuit, the embodiment of FIG. 6 uses two capacitors and two diodes to produce full wave rectification of an AC power signal for driving the light string. The full wave rectifying LED light string 600 not only dramatically reduces the electrical power consumption of the light string, but also provides a nearly constant average current that is not sensitive to loads to drive the LED string. As illustrated in FIG. 6, the capacitive full wave rectified LED light string 600 comprises three parts, i.e. front adapter 602, a back adapter 604 and a paired LED light string 606. The front adapter 602 comprises two AC ports 608, 610, a capacitor 612 and a diode 614. The back adapter comprises two AC ports 616, 618, capacitor 620 and a diode 622. The LED string 606 comprises a string of parallel connected LEDs.

In operation, during the positive half of the AC signal, when AC port 608 is positive compared to AC port 610, the electric current follows a path from ports 608, 616 to capacitor 612, to LED light string 606, to diode 622 and to AC port 618. When the AC input is positive at AC port 610 compared to the AC port 608, the circuit of FIG. 6 operates in a similar manner to rectify the signal.

The charging and discharging capabilities of capacitors, in general, make it possible for AC current to pass through the circuit in the manner described above. Therefore, a positive full wave is always applied to LED string 606. The capacitors 612, 620 also work as a voltage divider to match the LED operating voltages, which is usually much lower than AC household voltage, so that the resistors are not needed to limit the current to the LED string 606. Because the capacitors have only imaginary impedance, the capacitors consume a very small amount of electrical power, unlike resistors. Moreover, because of the large impedance of the capacitors at low frequencies, the slowly varying current component through the LEDs is not sensitive to the number of LEDs. Therefore, the same front adapter 602 and back adapter 604 can be used for strings with different numbers of LEDs without any modification. The advantage of the full wave rectified LED light string 600 of FIG. 6 is that the simple addition of a front adapter 602 and a back adapter 604 can provide an inexpensive and simple way of creating a full wave rectified signal, as well as providing a constant current supply.

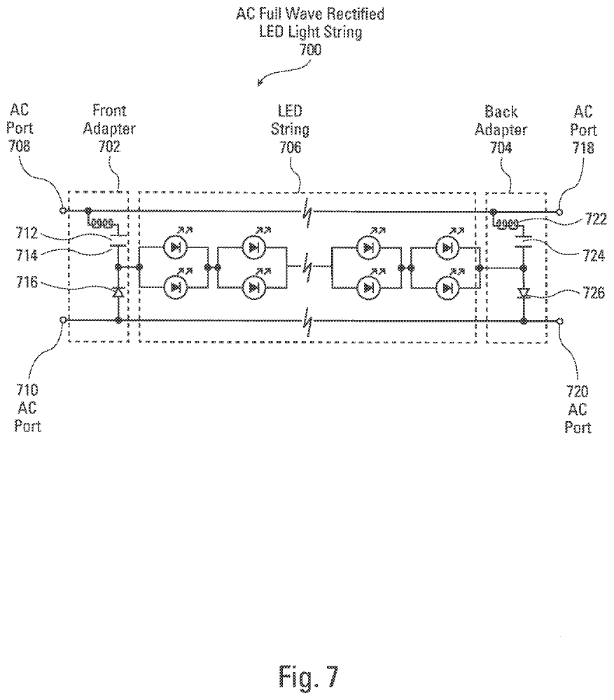

FIG. 7 is another embodiment of a full wave rectified LED light string 700. The full wave rectified LED light string 700 has a front adapter 702 and a back adapter 704. AC input ports 708, 710 are connected to the front adapter 702. Similarly, AC port 718, 720 are connected to back adapter 704. Front adapter 702 includes an inductor 712 that is connected to AC port 708 and capacitor 714. The anode of diode 716 is connected to the capacitor 714 and to the LED string 706. The anode of diode 716 is connected to the AC port 710. Back adapter 704 includes a series connected inductor 722 and capacitor 724. One side of the inductor 722 is connected to AC port 718 while the other side of the inductor 718 is connected to the capacitor 724. An anode of the diode 726 is connected to the capacitor 724 and the second end of the LED strings 706. The cathode of the diode 726 is connected to the AC port 720.

In operation, the full wave rectified LED light string 700, illustrated in FIG. 7, is similar to the operation of the full wave rectified LED light string 600 of FIG. 6. However, inductors 712, 722 are added to limit current spikes. Current spikes can occur during the charging and discharging of the capacitors 714, 724. Inductors 712, 722 are made sufficiently large to limit the current spikes that may occur as a result of charging and discharging of the capacitors 714, 724. The advantage of the embodiment of FIG. 7 is that the inductors 712, 722 and capacitors 714, 724 primarily exhibit imaginary impedance, such that energy is stored in these components. As a result, very little energy is consumed in the front adapter 702 and back adapter 704. As a result, the temperature of the front adapter 702 and the back adapter 704 is minimized, which allows the full wave rectified LED light string 700 to be used in both a safe and efficient manner.

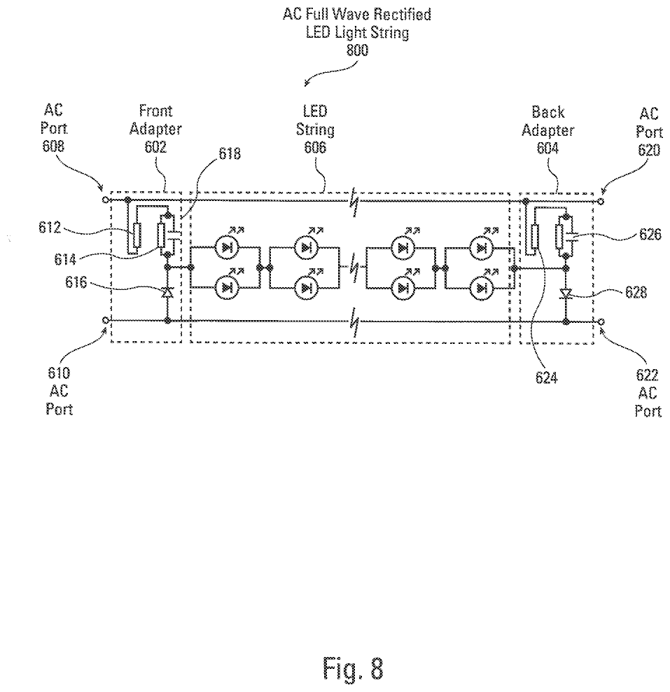

FIG. 8 is a schematic diagram of another embodiment of a full wave rectified LED light string 800. The electrical performance of the full wave rectified LED light strings 600 and 700 can be modified by the addition of resistors 612, 614, 624, 625 in light string 800. The full wave rectified LED light string 800 comprises three parts, i.e., a front adapter 602, a back adapter 604 and an LED string 606. The front adapter 602 has two AC ports 608, 610, a capacitor 618, a diode 616, a first resistor 612 and second resistor 614. The back adapter comprises two AC ports 620, 622, a capacitor 626, a diode 628, a first resistor 624 and second resistor 625. The LED string 606 comprises a string of series connected LED pairs.

In operation, during the positive half of the AC input, the electrical current follows the path from port 608 to first resistor 612, to capacitor 618 in parallel with resistor 614, to the LED string 606, to diode 616, and finally to ports 610, 622. During the negative half of the AC input when AC port 610 is higher than AC port 608, the electrical current follows a path from port 610 to diode 616, to LED string 606, to capacitor 618 in parallel with resistor 614, to resistor 612 and to port 608. Hence, a positive full wave rectified signal is applied to LED string 606 during both positive and negative going portions of the AC signal.

In principle, the operation of the circuit of FIG. 8 is similar to the operation of the circuits of FIGS. 6 and 7. In the front adapter 602, the resistor 614 is connected in parallel with the capacitor 618. The parallel connection is then connected in series with the resistor 612. In the back adapter, resistor 625 is connected in parallel to capacitor 626. The parallel connection is then connected in series with resistor 614. The resistors 612, 614, 624, 625 limit the charging current of the capacitors during charging periods of the capacitors 618, 626. Resistors 614, 625 are used to provide discharging loops for the capacitors 618, 626, respectively, during discharging periods. The use of these additional resistors can reduce the charging and discharging current spikes that occur at the LEDs with, however, some additional power consumption by the added resistors. Series connected inductors can also be used to limit current spikes.

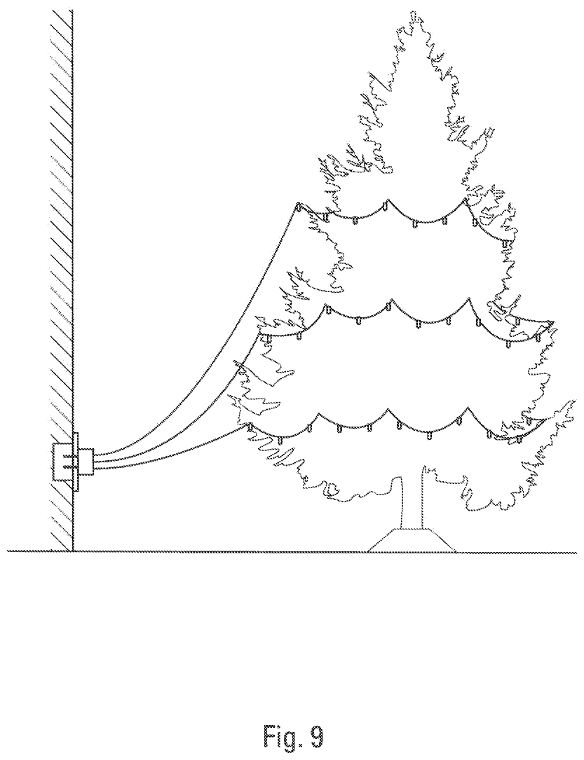

FIG. 9 is a schematic illustration of the manner in which different channels of light strings can be applied to a Christmas tree. Since there are separate strings from separate channels, the tree can be easily decorated in sections with shorter LED light strings. In addition, the strings can be easily removed without the necessity of unwinding a very long light string. Further, different portions of the tree can be lit in different ways and controlled in various different ways.

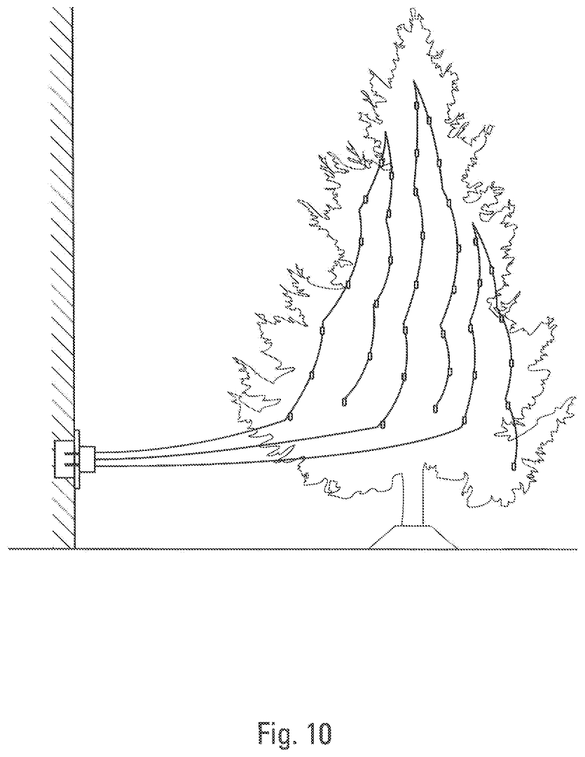

FIG. 10 is an illustration of another embodiment illustrating the manner in which a Christmas tree can be decorated in an alternative manner. Again, the ability to use shorter strings that can be applied to and removed from the tree in an easier manner provides a large advantage over long series connected strings which have large unsightly connectors located in the tree.

Present invention therefore provides several embodiments which allow for the implementation of more than one light string connected to more than one channel. The use of multiple channels to connect to multiple light strings allows for easy placement and removal of shorter light strings and allows for simple and easy control of these light strings. Additional light strings can be connected in series in each one of the channels, if desired, to provide a longer string. An optional bypass power lead 144, illustrated in FIG. 1, allows for multiple series connected additional light strings that can be operated at full power and illumination. The miniaturized circuit illustrated in FIG. 4 allows for a miniaturized AC to DC converter 106 that can be used in the wall plug 102 of FIG. 1. The adaptable LED light string 500 of FIG. 5 is not sensitive to load and can be operated with as few or as many LEDs as desired in each of the light strings. Inexpensive adapters are used to minimize power consumption, do not get hot, and provide a safe and efficient light string. In addition, as many series connected light strings as desired can be employed for each channel, which may be very useful in large outdoor environments.

The foregoing description of the invention has been presented for purposes of illustration and description. It is not intended to be exhaustive or to limit the invention to the precise form disclosed, and other modifications and variations may be possible in light of the above teachings. The embodiment was chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments of the invention except insofar as limited by the prior art.

What is claimed is:

1. A method of making an adaptable light emitting diode (LED) alternating current light string system comprising:
applying an AC signal to a controller,
generating a plurality of light string channels from said controller,
applying said plurality of light string channels to a plurality of front adapters;
connecting said plurality of front adapters to a plurality of light strings;
connecting said plurality of light strings to a plurality of back adapters;
connecting said plurality of front adapters and said plurality of back adapters in said plurality of light strings to produce a full wave rectified DC signal that is connected to a plurality of LEDs in said plurality of light strings;
controlling said plurality of light strings using said controller.

2. The method of claim 9 further comprising:
providing receptacles on each of said plurality of light string channels;
providing plugs on one end of each of said plurality of light strings so that a user can select a number of light strings used in said adaptable LED alternating current light string system.

3. The method of claim 10 further comprising:
providing receptacles on another end of each of said plurality of light strings so that a user can plug additional light strings into said plurality of light strings.

4. An adaptable light emitting diode (LED) alternating current light string system comprising:
a wall plug connected to an alternating current source;
a controller connected to said wall plug that generates a plurality of light string channels that are separately controlled by said controller,
front adapter circuits connected to said plurality of light string channels;
a plurality of LED light strings connected on a first end to said front adapter,
back adapter circuits connected to a second end of said plurality of LED light strings so that said front adapter and said back adapter are connected to function together to generate a full wave rectified DC signal;
a plurality of LEDs disposed in said plurality of LED lights strings that are connected to said full wave rectified DC signal that are illuminated in response to said controller.

5. The system of claim 12 wherein said controller is controlled by a remote controller.

6. The system of claim 12 further comprising:
receptacles disposed on each of said plurality of light string channels;
plugs connected to said front adapter circuits that allow a user to connect light strings to said plurality of light string circuits.

7. The system of claim 14 further comprising:
receptacles connected to said back adapter circuits which receive plugs from additional light strings connected in series with said plurality of LED light strings.
